(19) United States
(12) Patent Application Publication
(10) Pub. No.: US 2008/0006656 A1
(43) Pub. Date: Jan. 10, 2008

(54) Lotion pump structure

(75) Inventor: Kun-Lung Tseng, Taichung Hsien (TW)

Correspondence Address: John S. Egbert;Egbert Law Offices, 7th Floor, 412 Main Street, Houston, TX, 77002, US

(73) Assignee: LIVING FOUNTAIN PLASTIC INDUSTRIAL Co., Ltd., Dali City (TW)

(21) Appl. No.: 11/483,316

(22) Filed: Jul. 10, 2006

(51) Int. Cl. G01F 11/00

(52) U.S. Cl. 222/321.9

(57) ABSTRACT

The present invention is a lotion pump structure, and the lotion pump structure includes a piston cylinder, shut-off valve, locking ring, pump, activating tube, piston and resilient component. A first ring groove and a second ring groove are on the tapered section of the activating tube of the piston cylinder, so that the protruding ring at the top of the inner ring wall of the piston can be connected to the first ring groove. The bottom edge of the inner ring wall connects the second ring groove. The sealing effect is increased when the piston is sliding up and down, and the drawing effect on the lotion is increased. The piston is supported better to prevent the piston from being bent out of shape, further extending the working life span of the piston.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a lotion pump structure, and more particularly to a structure of a piston and other components.

### BACKGROUND OF THE INVENTION

The principle of a functioning conventional lotion pump is primarily use of movement, such as pressing and restoring, to drive a piston. The piston inside the piston cylinder is made to go up and down, and a shut off valve at the bottom of the piston cylinder is used to pump up the lotion.

Using the pump to pump up lotion has advantages and disadvantages. The structure of the piston is the key to this pump, and the seal between the piston and its components is an important factor that affects the pumping effectiveness and stability of the lotion. During the process when the piston is moving up and down inside the piston cylinder, the piston has issues, such as not being sealed completely as well as being out of shape. These issues can cause the vacuum effect created during the movement of the piston to not achieve desired conditions for pumping. Moreover, the sealing part of the piston and its related components lack support, such that the structures and function of the conventional lotion pump are not open to innovation not able to be developed.

Thus, to overcome the aforementioned problems of the prior art, it would be an advancement in the art to provide an improved structure that can significantly improve efficacy.

To this end, the inventor has provided the present invention of practicability after deliberate design and evaluation based on years of experience in the production, development and design of related products.

### BRIEF SUMMARY OF THE INVENTION

The lotion pump structure of the present invention primarily adds a first and second ring groove 46, 47 on the tapered section 42 of the activating tube 40 of the piston cylinder 10, so that the protruding ring 53 at the top of the inner ring wall 51 of the piston 50 can be connected to the first ring groove 46. The bottom edge 54 of the inner ring wall 51 connects the second ring groove 46. Thus, the sealing effect is increased when the piston is sliding up and down, and the drawing effect on the lotion is increased. The piston 50 is supported better to prevent the piston from being bent out of shape, further extending the working life span of the piston.

The protruding ring 53 placed on the top end of the inner ring wall 51 of the piston 50 can in an angle that leans outward, and the bottom of the protruding ring 53 forms a limit blocking edge 531. The limit blocking edge 531 can be placed against the upper limit ring surface 44. Therefore, the protruding ring 53 mentioned above can be double sealed with the limit blocking edge 531, which makes the sealing effect between the inner ring wall of the piston 50 and the activating tube 41 better.

The bottom edge 54 of the inner ring wall 51 of the piston 50 and the second ring groove 47 placed on the lower limit ring surface 45 can be connected in a cone shaped angle. When the bottom edge 54 touches the second ring groove, it can use the principle of guidance by cone angle surface to connect.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows the first sectional view of the structure of the lotion pump, which is not in use.

FIG. 2 shows an enlarged view sectional view of part A of FIG. 1.

FIG. 3 shows a partial sectional and perspective view of the piston component of the present invention.

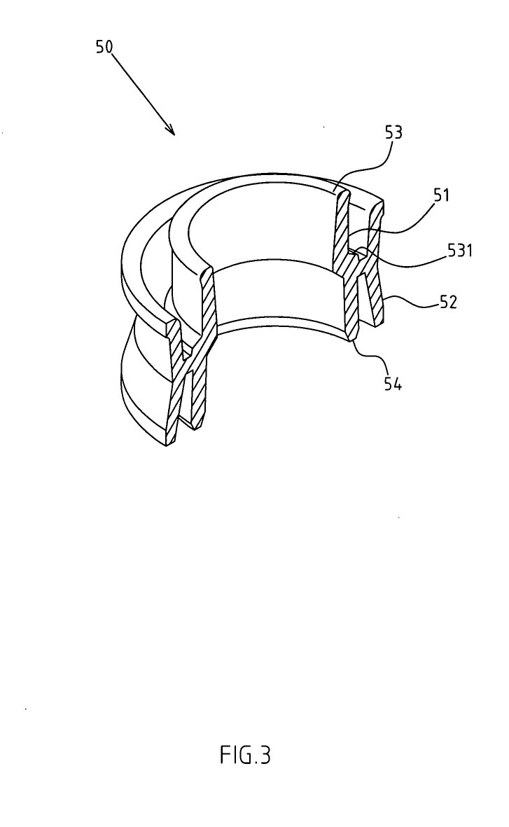

FIG. 4 shows a second sectional view of the structure of the lotion pump, when the pump and activating tube is pushed up.

FIG. 5 shows an enlarged sectional view of part B of FIG. 4.

FIG. 6 shows a third sectional view of the structure of the lotion pump when the pump and activating tube is pushed down.

FIG. 7 shows another sectional view of an embodiment of the resilient component of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

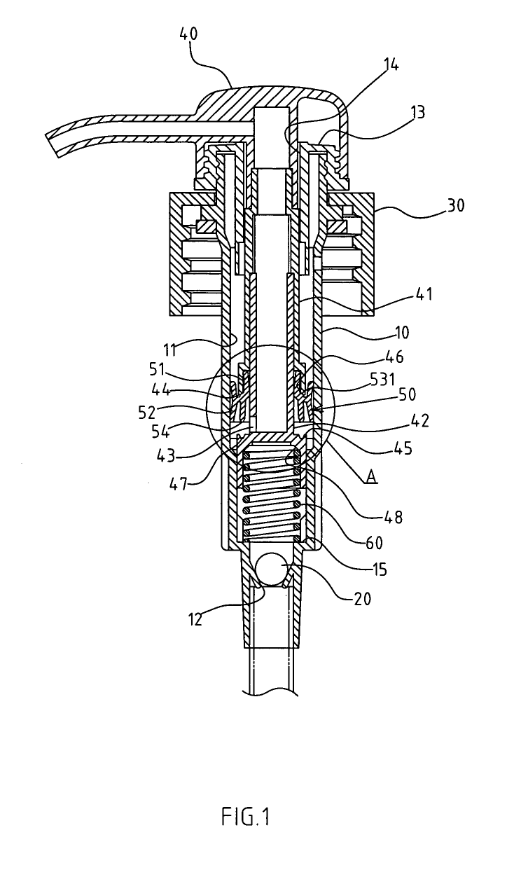

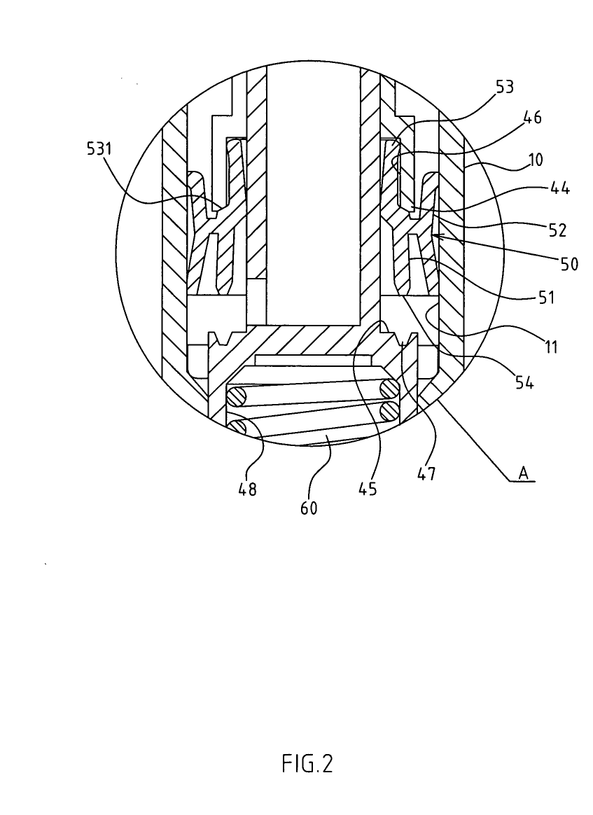

As shown in FIGS. 1 and 2, there is the preferred embodiment of the lotion pump disclosed in the present invention.

A piston cylinder has a containment slot 11 formed inside, and the bottom of the containment slot 11 has an opening 12 in cone shape. The top of the containment is sealed by a tip seat 13, and a through hole 14 is placed in the center of the tip seat 13. The through hole 14 is connected to the containment slot 11.

A shut-off valve 20 can be a steel ball, that can be placed at the opening 12 of the containment slot 11 of the piston cylinder 10.

A locking ring 30 is placed on the outside of the top end of the piston 10.

A pump 40 has an activating tube 41 at its bottom, and the activating tube 41 goes through the through hole 14 of the tip seat 13 mentioned above. The activating tube 41 is placed the bottom of the activating tube 41 inside the containment slot 11 of the piston cylinder 10 in a condition that can be moved up and down. A tapered section 42 is placed at the bottom of the activating tube 41, and the tapered section 42 has a flow hole 43. An upper limit ring surface 44 and a lower limit ring surface 45 are placed on the top and bottom end of the tapered section 42. A first ring groove 46 is placed on the upper limit ring surface 44, and a second ring groove 47 is placed on the lower limit surface 45.

A piston 50 is placed on the tapered section 42 of the activating tube 41 mentioned above in a sliding condition, and the piston 50 includes an inner ring wall 51 and an outer ring wall 52. The outer ring wall 52 is placed against the containment slot 11 inside the piston cylinder 10, and a protruding ring 53 is formed on the top end of the inner ring wall, which can be connected to the first ring groove 46 of the upper limit ring surface 44. The bottom edge 54 of the inner ring wall 51 can be connected to the second ring groove 46 of the lower limit surface 45.

A resilient component 60 can spring upward by pressing down on the activating tube 41.

As shown in FIG. 1, the resilient component 60 can be a spring, and it can be placed between the bottom of the activating tube 41 and a containment slot 11. A slot 48 is placed on the bottom of the activating tube 41 for the top of the resilient component to connect, and an annular shoulder 15 is placed at the bottom of the containment slot 11 for the bottom of the resilient component 60 to be placed against.

The protruding ring 53 placed on the top end of the inner ring wall 51 of the piston 50 can be at an angle that leans outward, and the bottom of the protruding ring 53 forms a limit blocking edge 531. The limit blocking edge 531 can be placed against the upper limit ring surface 44. By this structure, the protruding ring 53 mentioned above can be double sealed with the limit blocking edge 531, which makes the sealing effect between the inner ring wall of the piston 50 and the activating tube 41 better.

The bottom edge 54 of the inner ring wall 51 of the piston 50 and the second ring groove 47 placed on the lower limit ring surface 45 can be connected in a cone shaped angle. By so doing, when the bottom edge 54 touches the second ring groove, it can use the principle of guidance by the cone angle surface to connect.

Through the above structure and design, the operation of the present invention is explained herein.

As shown in FIG. 1, the pump 40 is lowered to the lowest positioned, and this position is the condition before the lotion pump is used. At this time, the pump is positioned through connecting the inner screw part 401 to the external screw part 131 placed on the outside of the tip seat 13, and the piston 50 part is as shown in FIG. 2. The protruding ring 53 at the top of the inner ring wall 51 is inserted into the first ring groove 46 at the upper limit ring surface 44 of the activating tube 41, and the limit blocking edge 531 at the bottom of the protruding ring 53 is placed against the upper limit surface 44. By so doing, the space between the piston 50 and the activating tube 41 is sealed completely.

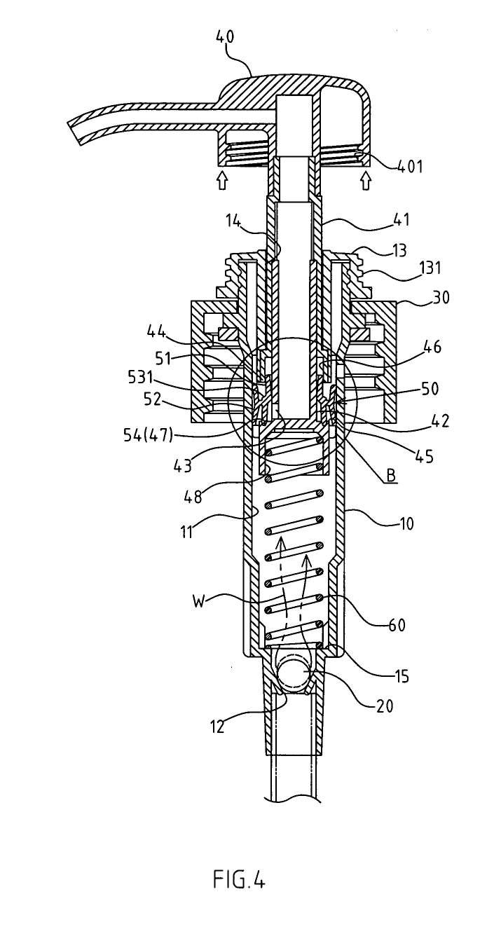

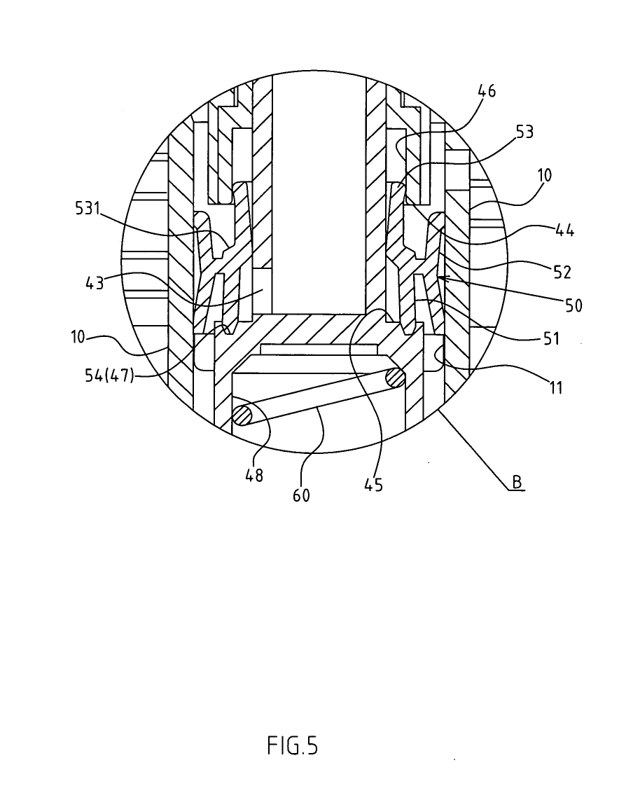

As shown in FIGS. 4 and 5, the condition when the pump is being used is shown. After twisting the pump to disconnect the inner screw part 401 from the external screw part 131 mentioned before, the pump sprung upward because the bottom of the activating tube 41 is pushed up by the resilient component 60. Therefore, when the activating tube 41 is pushed up, the second ring groove 47 of the lower limit ring surface 45 connects to the bottom edge 54 of the inner ring wall 51 of the piston 50, which makes the space between the piston 50 and the activating tube 41 sealed tightly. A better vacuum effect is created when the piston is pushed up, and when this vacuum is created, it draws lotion from the opening 12 into the containment slot 11 inside the piston cylinder 10, and it creates a shut-off effect by shut-off valve 20.

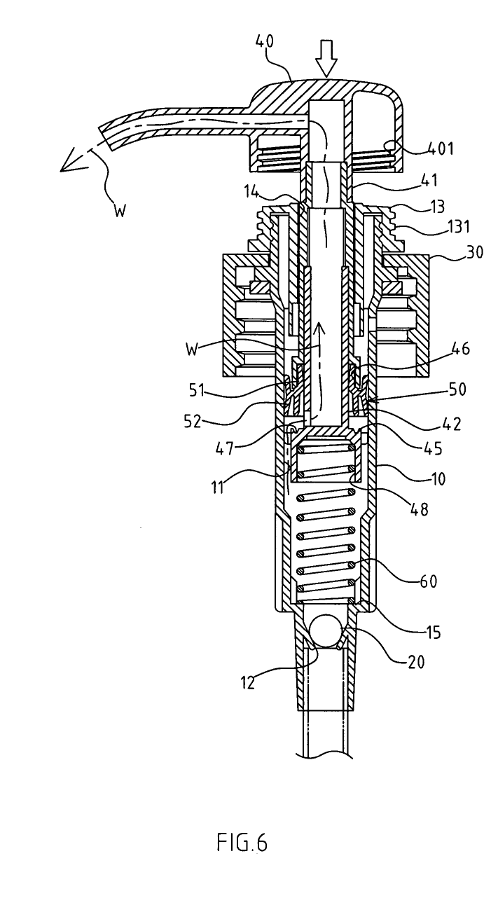

As shown in FIG. 6, the pump 40 is pressed down to drive the activating tube 41 and piston 50 down. When the activating tube 41 slides down, because the fraction between the outer ring wall 52 of the piston 50 and the containment slot 11 of the activating tube 41 is greater than the fraction between the inner ring wall 51 and the activating tube 41, the speed for the piston 50 to go down is slower. The protruding ring 53 at the top of the inner ring wall 51 of the piston 50 is made to connect to the first ring groove 46 at the upper limit ring surface 44 of the activating tube 41. The second ring groove 47 of the lower limit ring surface 45 separates from the bottom edge 54 of the inner ring wall 51 of the piston 50 and brings the function of the flow hole 43 to its full effect. The lotion W is drawn from the space between the opening 12 and the activating tube 41 into the inside of the activating tube 41, and the lotion W comes out from the pump 40.

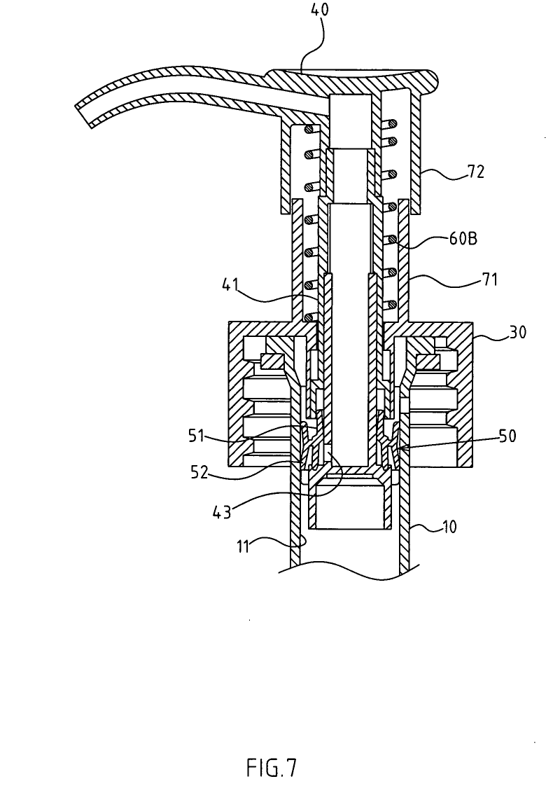

As shown in FIG. 7, the resilient component 60B is placed on the outside of the top of the activating tube 41, and the top of the resilient component 60B is pushed against the bottom of the pump 40. The inner casing 71 and outer casing 72 are formed between the top of the locking ring 30 and the bottom of the pump 40, which covers the resilient component 60 to create protective, anti-dust and beautifying effect.

I claim:

1. A lotion pump structure, comprising:
a piston cylinder, having a containment slot formed inside and an opening in cone shape at a bottom of said containment slot, a top of said containment slot being sealed by a tip seat, said tip seat having a through hole placed in a center of said tip seat, said through hole being connected to said containment slot;
a shut-off valve being comprised of a steel ball, said steel ball being placed at said opening of said containment slot of said piston cylinder;
a locking ring, being placed on an outside of a top end of said piston cylinder;
a pump, having an activating tube at a bottom thereof, said activating tube passing through said through hole of said tip seat and being placed a bottom of said activating tube inside said containment slot of said piston cylinder so as to be able to be moved up and down, said activating tube having a tapered section placed at a bottom of said activating tube, said tapered section having a flow hole, an upper limit ring surface, and a lower limit ring surface, said upper limit ring surface and said lower limit ring surface being placed on top and bottom ends respectively of said tapered section;
a first ring groove, being placed on said upper limit ring surface;
a second ring groove, being placed on said lower limit surface;
a piston, being placed on said tapered section of said activating tube in a sliding condition, said piston having an inner ring wall and an outer ring wall, said outer ring wall being placed against said containment slot inside said piston cylinder;
a protruding ring, being formed on a top end of said inner ring wall and connected to said first ring groove of said upper limit ring surface, a bottom edge of said inner ring wall being connected to said second ring groove of said lower limit surface; and
a resilient component, being able to spring upward to restore position by pressing down on said activating tube.

2. The lotion pump structure defined in claim 1, wherein said resilient component is placed between a bottom of said activating tube and a second containment slot, said activating tube having a slot placed on a bottom of said activating tube for a top of said resilient component to connect, said second containment slot having an annular shoulder placed at a bottom thereof, said annular should being placed against a bottom of said resilient component.

3. The lotion pump structure defined in claim 1, wherein said resilient component is placed on an outside of said top of said activating tube, a top of said resilient component being placed against a bottom of said pump, a bottom of said resilient component being placed against a top of said locking ring.

4. The lotion pump structure defined in claim 1, wherein said protruding ring is placed on said top end of said inner ring wall at an angle that leans outward, a bottom of said protruding ring forming a limit blocking edge, said limit blocking edge being placed against said upper limit ring surface.

5. The lotion pump structure defined in claim 1, wherein a bottom edge of said inner ring wall and said second ring groove placed on said lower limit ring surface are connected in a cone shaped angle.
